(19) United States
(12) Patent Application Publication
(10) Pub. No.: US 2004/0189602 A1
(43) Pub. Date: Sep. 30, 2004

(54) Intelligent docking station integrated within a keyboard form factor for a handheld computer

(76) Inventors: Bryan A. Scott, Plano, TX (US); Ramon Perales, Plano, TX (US)

Correspondence Address: Steven Thrasher, 391 Sandhill Dr., Richardson, TX, 75080, US

(21) Appl. No.: 10/821,433

(22) Filed: Apr. 9, 2004

Related U.S. Application Data
(63) Continuation-in-part of application No. 10/288,846, filed on Nov. 6, 2002.

(51) Int. Cl. G09G 5/00

(52) U.S. Cl. 345/156

(57) ABSTRACT

The invention is an intelligent docking station integrated within a keyboard form factor that enables a user to input data into a handheld computer and access network connectivity.

### RELATED APPLICATIONS

This patent application is a continuation in part of, is related to, and claims priority from co-owned and assigned U.S. patent application Ser. No. 10/288,846 to Scott, et al. entitled MANIPULATING THE POSITION OF A HORIZONTAL-VERTICAL VISUAL INDICATOR ON A PDA DISPLAY VIA A ONE-HAND MANUAL SCREEN HORIZONTAL-VERTICAL VISUAL INDICATOR DEVICE, filed on Nov. 6, 2002, which is entirely incorporated by reference herein.

### TECHNICAL FIELD OF THE INVENTION

The invention relates to handheld computer data entry.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

PCs are typically bulky, require large amounts of power, and occupy a large amount of surface area, called a “footprint.” “Handhelds” (or handheld computers) include personal digital assistants (PDAs), smart phones, and other small computing devices, provide significant computing power in a small device that uses relatively little power. Unfortunately, handhelds do not offer the most user-friendly input/output devices, such as a keyboard and mouse. Instead, a user of a handheld must be content with using a stylus, very small buttons, or other data entry devices. Accordingly, it is desirable to provide a device, system, and method for integrating the conveniences of a handheld with the conveniences of a PC. The invention provides such devices, systems, and methods.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates a block diagram of a limited feature intelligent docking station keyboard (the keyboard); and

FIG. 2 is a block-flow diagram of an intelligent docking station keyboard algorithm.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

### HANDHELD COMPUTER SYSTEMS AS SOFTWARE PLATFORMS

A handheld computer system typically comprises hardware capable of executing machine-readable instructions, as well as software for executing acts typically as machine-readable instructions that produce a desired result. In addition, a handheld computer system may include hybrids of hardware and software, as well as computer sub-systems.

Software may be defined as machine code stored in memory, such as RAM or ROM, or machine code stored on devices (such as memory card, for example). Software may include executable code, an operating system, or source or object code, for example. In addition, software encompasses any set of instructions capable of being executed in a client machine or server—and, in this form, is often called a program or executable code.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes called an act. Accordingly, software may be used to perform a method that comprises acts. In the present discussion, sometimes acts are referred to as steps to help the reader more completely understand the exemplary embodiment.

Software also includes description code. Description code specifies variable values and uses these values to define attributes for a display, such as the placement and color of an item on a displayed page. For example, the Hypertext Transfer Protocol (HTTP) is the software used to enable the Internet and is a description software language.

Hybrids (combinations of software and hardware) are becoming more common as devices for providing enhanced functionality and performance to computer systems. A hybrid is created when traditionally software functions are directly manufactured into a silicon chip—this is possible since software may be assembled and compiled into ones and zeros, and, similarly, ones and zeros can be represented directly in silicon. Typically, the hybrid (manufactured hardware) functions are designed to operate seamlessly with software. Accordingly, it should be understood that hybrids and other combinations of hardware and software are also included within the definition of a computer system and are thus envisioned by the invention as possible equivalent structures and equivalent methods.

Handheld computer sub-systems are combinations of hardware or software (or hybrids) that perform some specific task. For example, one computer sub-system is a soundcard. For example, a soundcard provides hardware connections, memory, and hardware devices for enabling sounds to be produced and recorded by a handheld computer system. Likewise, a soundcard may also include software needed to enable a computer system to “see” the soundcard, recognize the soundcard, and drive the soundcard.

Methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

Description of the Drawings

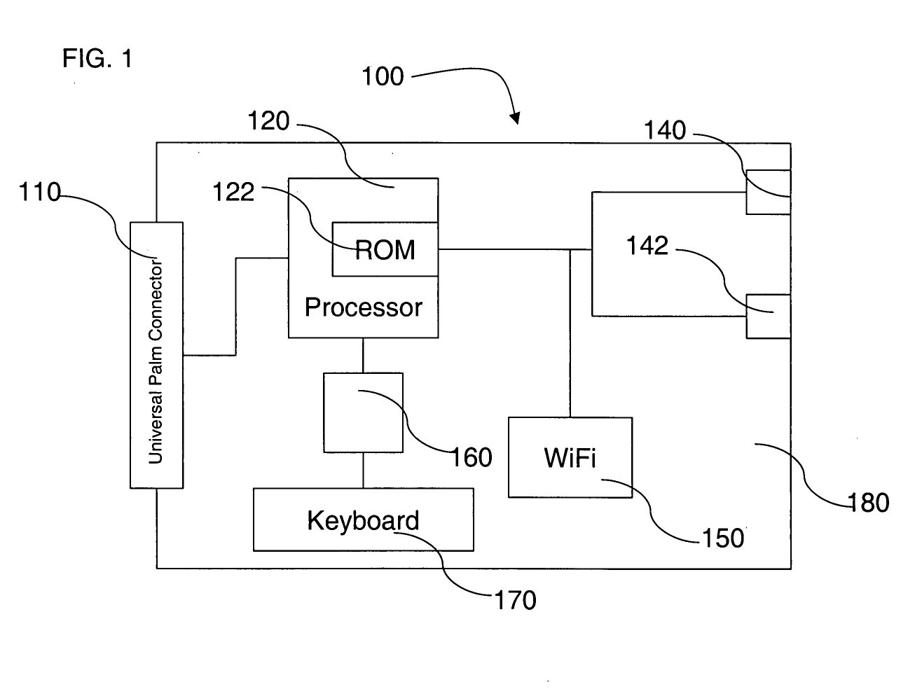

Reference is now made to the figures, and in particular with reference to FIG. 1, which illustrates a block diagram of a limited feature intelligent docking station keyboard (the keyboard) 100 that supports bidirectional data flow from the keyboard 100 to a handheld computer. The keyboard 100 generally defines components, architecture, methods, and feature sets that enable a user to more easily interface with a handheld computer. The keyboard 100 typically includes a port 110 that is a means for coupling the keyboard 100 to a handheld computing device such as a smart phone, or personal digital assistant (PDA), for example, and is preferably a Universal Serial Palm Connector. Hereinafter, the exemplary embodiment is discussed with respect to a PDA, but is equally applicable to any handheld computing, mobile, or portable device. Of course, other ports for coupling a PDA to another device are known in the art (both via hardware and wireless connections), and any such coupling is within the scope of the invention.

Additionally, the keyboard 100 also includes a processor 120, or state machine capable of executing logic, for example. The processor 120 provides functionality to the keyboard 100, and more specifically, the processor 120 is configured to allow the keyboard 100 to couple an input device, such as a mouse, to a PDA that is coupled to the keyboard 100. The processor 120 also facilitates communication with the keyboard's client docking software (resident on the PDA), and also facilitates data aggregation (keyboard, mouse, and network data) to the client docking software. Included on or attached to the processor is a ROM 122, preferably EEPROM, which may store an embedded operating system or other form of processor control logic as known to those skilled in the art of processors that is adapted to provide functionality to embedded software. Also coupled to the processor 120 is a network interface 150 that in a preferred embodiment that is compliant with the IEEE 802.11 a, b, and g standards (WiFi), however, alternative embodiments may include Bluetooth, GPRS, Edge, and other RF Technologies know to those skilled in the art of network connections.

The keyboard 100 includes ports that couple to input devices and that may couple to simple output devices. In one embodiment, the keyboard 100 includes a second port that is preferably a mouse port 140, and an optional third port that preferably is a simple output device port such as an audio port 142. Of course, input devices are known in the art as passive devices that allow a user to communicate with a computing device, and do not typically have active processing power of their own.

The mouse port 140 is preferably common PS2 port, which is commonly used on PCs. For example, a PS2 keyboard port may be coupled to a standard 104 keyboard to provide additional functionality to the invention, and a PS2 mouse port couples to a standard two or three button mouse, or mouse with a scroll wheel, such as an Intellimouse®. However, it should be understood that while PS2 ports are preferred, other ports, including wireless ports, short-range wireless ports such as 802.11 and Bluetooth ports, and USB ports are known in the computer art, are apparent after reading the present disclosure, and may be incorporated into the invention without departing from its scope.

Embedded software resident on the cradle is preferably embedded in the ROM 122. The embedded software provides several aspects to the invention's functionality. First, the embedded software is adapted to initiate a docking event when it is detected that a PDA is coupled to the port 110. Following the docking event, the embedded software establishes a communication link between the PDA and client docking software. Second, after docking, the embedded software activates the communication link by detecting serial (keyboard and mouse) data and packet data (network data), and then aggregates both data types into a stream of data elements that are then transmitted to the client docking software. Third, the embedded software provides for user control of the keyboard repeat rate and repeat delay, mouse speed, and network interface configuration, in a manner known in the operating system programming arts.

The keyboard 100 includes a keyboard form factor 180 that substantially resembles keyboard form factors commonly known to most persons, and especially known to those of ordinary skill in the art, such as standard 104 key PC keyboards, handheld computing portable or travel (collapsible) keyboards, or PDA thumb board, for example. However, it is certainly unknown for any keyboard form factor to have a port 110, input ports 140, 142, output ports 142, network interface 150, or internal intelligence 120 and even more so, a keyboard form factor that has ports that couples to a handheld computer. In any event, the keyboard form factor 180 incorporates forms known and future forms without departing from the scope or spirit of the invention. The keyboard form factor 180 maintains a plurality of keyboard keys (keys) 170 as known in the keyboard arts. The keys 170 may include a synchronization button as a key, and may also include other special function keys. As is known in the keyboard art, a keyboard processor 160 is used to generate ASCII signals, and particularly, the keyboard processor 160 generates a predefined ASCII signal representative of a key when that key is articulated.

The embedded software preferably includes a keyboard interface that accepts signals (typically ASCII values) coming from the keyboard processor 160, and then translates those signals into a second set of signals (typically a different set of ASCII values) that are understood by the particular handheld computer that is coupled to the port 110. Accordingly, when a key is pressed on a keyboard, data is sent to the processor (which may be embodied as a microcontroller), likely via the keyboard processor 160. After the processor 120 receives an operation initiated by a key pressed, the processor 120 sends a byte representing the ASCII value of that key out the serial port 110 to the handheld OS in the proper format for the handheld OS, preferably using standard RS232 communications. Some values of the ASCII range are not able to produce characters and should be used for special characters and as an alternative to mouse control.

The embedded software also preferably includes a mouse interface, which receives and translates mouse positioning and input signaling using a similar protocol, and also preferably using ASCII characters. When the mouse is moved or a button is pressed, the data is converted into a series of ASCII characters that distinguish the data from keyboard data. PDA OSs, such as the Palm® OS or the Pocket PC® OS, presently have no idea what to do with a multi-button mouse, so mouse button events are presently preferably interpreted as a single mouse button (ex. left-mouse-down and right-mouse-down are the same). However, as PDA OSs develop, additional button functionality may be developed and falls within the scope of the claims.

Client docking software comprises a driver and a software application, and is loaded into a PDA during an installation process (typically the first docking event between a PDA and the cradle keyboard 100). The client docking software, in one embodiment, includes a virtual communication driver (VCD) that resides on the handheld computer. The VCD is a serial driver that continuously monitors serial data received from the embedded software. The VCD is preferably mapped to all PDA applications such that when keyboard data is received, the applications respond as they have received data from a graphiti pad or an on-screen keyboard retrospectively, for example. In addition, the VCD is preferably mapped to applications such that when mouse data is received, applications respond as if they have received data from a touch screen or a jog dial, for example.

In addition, the client docking software preferably includes a control panel application. The control panel application allows a user to configure settings for an attached input device, simple output devices, and/or network interface. Common configurable for keyboard and/or mouse settings retrospectively include a repeat rate, a repeat delay, and a cursor blink rate, for example. Preferably, these settings are adjustable via a slider control, which is known in the art. Other common configurable settings include a hide pointer setting, an enable/disable mouse buttons setting, and an enable/disable scrolling setting, for example. Preferably, these settings are adjustable via a check box, which is known in the art. Adjusting the settings via the client docking software preferably directly changes settings in the embedded software.

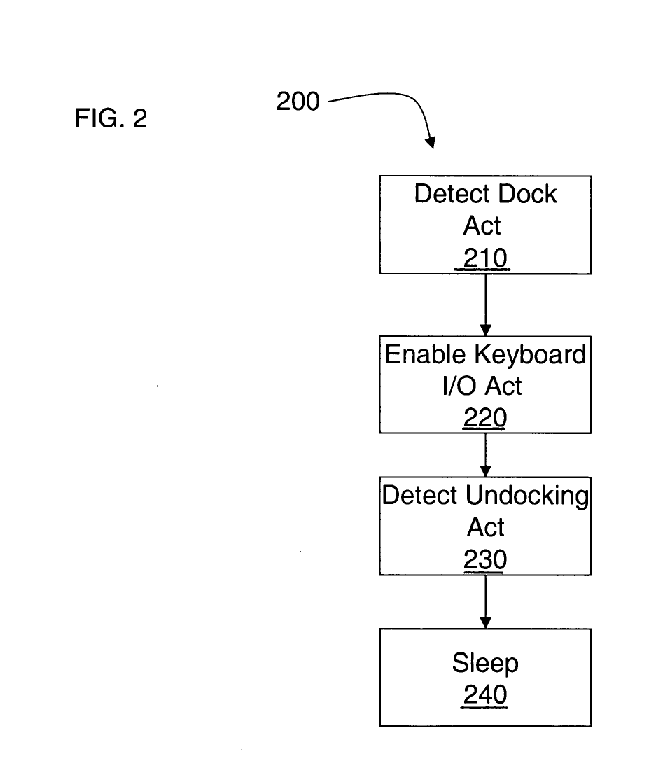

FIG. 2 is a block-flow diagram of a keyboard algorithm 200. The following discussion of the keyboard algorithm 200 incorporates specifics discussed above. The keyboard algorithm 200 begins with a detect dock act 210 in which the keyboard algorithm 200 detects a handheld computer coupled to a port integrated with a keyboard form factor. Next, in an enable keyboard I/O act 220, the keyboard algorithm 200 enables the keyboard keys, mouse and network connectivity coupled to or embedded within the keyboard. In a preferred embodiment, a mouse cursor will appear on the handheld computer screen once the enable keyboard I/O act 220 has occurred.

Thereafter, eventually the handheld will be undocked and this event is detected in a detect undocking act 230, which initiates a keyboard shutdown and sleep mode in a sleep act 240. Of course, it is understood that in the forgoing keyboard algorithm 200, keyboard cycle view is taken, as any several combinations of the forgoing acts yield new and novel methods of implementing software. Accordingly, any method should be interpreted only as indicated in the claims.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. An apparatus, comprising:
a port integrated within a keyboard form factor;
the port adapted to couple with a handheld computer;
a processor maintained in the keyboard form factor, the processor coupled to the port;
a network interface coupled to the processor;
at least one keyboard key coupled to the processor;
the processor having memory; and
the memory stores code that enables the network interface and at least one keyboard key coupled to the processor to communicate with a handheld computer coupled to the port.

2. The apparatus of claim 1 wherein the port is a Universal Serial Palm Connector.

3. The apparatus of claim 1 wherein the processor is an embedded processor.

4. The apparatus of claim 1 wherein the code is adapted to configure a network connection.

5. The apparatus of claim 1 further comprising a keyboard processor coupled to the processor and to at least one keyboard key, the keyboard processor generates a unique character associated with a key when the key is articulated.

6. The apparatus of claim 1 wherein the keyboard form factor is a collapsible travel handheld computer.

7. The apparatus of claim 1 wherein the keyboard form factor is a PDA thumb board.

8. The apparatus of claim 1 wherein the second port comprises a USB port.

9. The apparatus of claim 1 wherein the handheld computer is a smart phone.

10. The apparatus of claim 1 wherein the handheld computer is a personal digital assistant.

11. The apparatus of claim 1 further comprising a second port coupled to the processor and integrated with the keyboard form factor whereby the second port is adapted to communicatively couple with a mouse.

12. The apparatus of claim 1 wherein the network connection is 802.11

13. The apparatus of claim 1 wherein the network connection is Bluetooth.

14. An apparatus, comprising:
a port integrated within a keyboard form factor;
the port adapted to couple with a handheld computer;
a processor maintained in the keyboard form factor, the processor coupled to the port;
a network interface coupled to the processor;
at least one keyboard key coupled to the processor;
a second port coupled to the processor and integrated with the keyboard form factor;
the second port adapted to communicatively couple with an input device;
the input device comprising a mouse;
the processor having memory; and
the memory stores a code that enables the input device coupled to the second port to communicate with a handheld computer coupled to the port.
the code is adapted to display a mouse cursor on a handheld computer display.

15. The apparatus of claim 14 wherein the second port is adapted to communicate with an input device via a short-range radio signal.

16. The apparatus of claim 14 wherein the short-range radio signal is an 802.11 signal.

17. The apparatus of claim 14 wherein the memory comprises a mouse interface that converts a mouse input value received on the second port into a signal representing that input value for a handheld computer coupled to the port.

18. The apparatus of claim 14 further comprising a virtual communication driver (VCD) in communication with the memory, the VCD resident on a handheld computer.

19. The apparatus of claim 14 wherein the memory comprises a mouse interface that converts a mouse input value received on the second port into a signal representing that input value for a handheld computer coupled to the port.

20. A method in a computer system, comprising:
detecting a docking event on a first port integrated with a keyboard form factor, the first port also being coupled to a processor maintained in the keyboard form factor;
automatically enabling an input device coupled to a second port to communicate with a handheld computer coupled to the first port; and
displaying on the handheld computer a cursor whose position is controlled by the input device;
the input device comprising a mouse; wherein
the first port and the second port are integrated within a keyboard.

21. The software system of claim 20 further comprising disabling the input elements of a handheld computing device that is coupled to the first port when a detect undocking act occurs.

22. The software system of claim 20 further enabling a sleep act after a detect undocking act occurs.
